(19) United States
(12) Patent Application Publication
(10) Pub. No.: US 2016/0187894 A1
(43) Pub. Date: Jun. 30, 2016

(54) SYSTEM AND METHODS FOR CONTROLLING BOILERS, HOT-WATER TANKS, PUMPS AND VALVES IN HYDRONIC BUILDING HEATING SYSTEMS

(71) Applicant: SHM CONTROLS INC., Vancouver (CA)

(72) Inventor: Oded Nisim Malky, Vancouver (CA)

(21) Appl. No.: 14/973,189

(22) Filed: Dec. 17, 2015

Related U.S. Application Data
(60) Provisional application No. 62/098,551, filed on Dec. 31, 2014.

(51) Int. Cl. G05D 23/13; F24D 19/10; F24D 3/02

(52) U.S. Cl. CPC G05D 23/1393; F24D 3/02; F24D 19/1009; F24D 19/1012; G05B 2219/2614

(57) ABSTRACT

A method and controller apparatus for controlling a boiler to supply water to a water loop in a hydronic building heating system is disclosed. The water loop passes through at least one suite in the building. The method involves receiving a suite temperature reading from a temperature sensor installed inside the at least one suite, causing the boiler to heat the supply water when the suite temperature reading is lower than a target temperature by an allowed variance, the target temperature being based on an expected activity in the suite, and causing the boiler to discontinue heating the supply water when the suite temperature reading is higher than the target temperature by an allowed variance. A method and controller apparatus for controlling a boiler to supply water to a water loop is also disclosed The method involves receiving an outside temperature reading from a temperature sensor installed outside of the at least one suite, determining a boiler idle temperature based on the outside temperature reading, controlling the boiler to supply water at the idle boiler temperature in response to a determination that heating of the water within the water loop is not currently required, and controlling the boiler to supply water at a temperature above the idle boiler temperature in response to a determination that heating of the water within the water loop is currently required.

### RELATED APPLICATIONS

This application claims the benefit of provisional patent application U.S. 62/098,551 entitled “SYSTEM AND METHODS FOR CONTROLLING BOILERS, HOT-WATER TANKS, PUMPS AND VALVES IN HYDRONIC BUILDING HEATING SYSTEMS”, filed on Dec. 31, 2014 and incorporated herein by reference in its entirety.

### BACKGROUND

1. Field

The present invention pertains hydronic building heating systems and in particular to control of heating system components.

2. Description of Related Art

Older apartment buildings (constructed before 1980) were typically not designed with heat efficiency in mind. The heating pipes in such buildings were initially designed to work with older oil boiler systems and were converted at a later stage to natural gas. The original piping system was usually kept with no change, making it less than ideal for working with the newer gas boilers. In order to determine if boiler heating is required, these systems generally relied on only a single temperature sensor located outside the building, and in some cases also a secondary thermostat located in the hallway. The amount of heat generated by the boiler is calculated using a “preset” generic temperature table based on the temperature outside the building. For every given outside temperature the boiler is thus turned on for a conforming preset percentage of the time. This method, although very common, is inaccurate. Since building managers do not want to deal with tenant complaints that often cannot be verified, they will simply increase the boiler heat, which means more natural gas is used than otherwise needed resulting in higher gas expenses.

To help improve on this situation, boilers in recent years are designed to work at a very high efficiency level (typically up to 98%). However the boiler is only one part of the entire heating system, which also includes the piping and the building layout. Even a high efficiency boiler cannot adjust for the inherent inaccuracy of the “preset” temperature table method described above, and also cannot rectify the heat loss created by exposed pipes, incorrect diameter piping, and/or pumps that are too strong or too weak.

### SUMMARY

In accordance with one disclosed aspect there is provided a method for controlling a boiler to supply water to a water loop in a hydronic building heating system, the water loop passing through at least one suite in the building. The method involves receiving a suite temperature reading from a temperature sensor installed inside the at least one suite, causing the boiler to heat the supply water when the suite temperature reading is lower than a target temperature by an allowed variance, the target temperature being based on an expected activity in the suite, and causing the boiler to discontinue heating the supply water when the suite temperature reading is higher than the target temperature by an allowed variance.

The target temperature may be pre-determined based on expected activity associated with one or more of a current time of day, expected sleeping time of an occupant of the suite, an expected vacancy of the suite, day of the week, weekend days, and statutory holidays.

Causing the boiler to heat the supply water may involve causing the boiler to heat the supply water at a time in advance of an increase in the target temperature by a period of time, the period of time being based on at least one of a time for the boiler to heat the supply water and a time for the heated supply water to heat the building.

The water loop may pass through a plurality of suites in the building and receiving the suite temperature reading may involve receiving a plurality of suite temperature readings from at least some of the plurality of suites and the method may further involve combining the plurality of suite temperature readings by at least one of averaging the plurality of suite temperature readings, determining a lowest suite temperature reading, determining a highest suite temperature reading, excluding any of the plurality of suite temperature readings that fall outside of a reasonable range of suite temperature readings, excluding any of the plurality of suite temperature readings having a time variation that fall outside of a reasonable time variation in suite temperature readings, and determining that none of the plurality of suite temperature readings fall within the reasonable range of suite temperature readings and initiating a pre-determined duty cycle for operation of the boiler.

The method may involve generating an alert in response to changes in suite temperature that are not correlated with operation of the boiler indicating possible overheating or under-heating of the building.

In accordance with another disclosed aspect there is provided a method for controlling a boiler to supply water to a water loop in a hydronic building heating system, the water loop passing through at least one suite in the building. The method involves receiving an outside temperature reading from a temperature sensor installed outside of the at least one suite, determining a boiler idle temperature based on the outside temperature reading, controlling the boiler to supply water at the idle boiler temperature in response to a determination that heating of the water within the water loop is not currently required, and controlling the boiler to supply water at a temperature above the idle boiler temperature in response to a determination that heating of the water within the water loop is currently required.

Receiving the outside temperature reading may involve receiving at least one of a temperature reading from a temperature sensor installed outside the building, and a temperature reading from a temperature sensor installed within the building but outside of the at least one suite.

The water loop may include a return line for returning water to the boiler from the at least one suite and the method may further involve receiving a water supply temperature reading from a temperature sensor disposed to measure a temperature of the supply water supplied to the water loop by the boiler, receiving a return line temperature reading from a temperature sensor located in the return line proximate the boiler, and generating an alert in response to a difference between the water supply temperature reading and the return line temperature reading exceeding a predetermined maximum temperature difference indicative of a possible failure in the water loop.

The method may further involve receiving a water supply temperature reading from a temperature sensor disposed to measure a temperature of the supply water supplied to the water loop by the boiler, and generating an alert in response to identifying a discrepancy in a time variation of the water supply temperature from a pre-determined heat supply time variation associated with the boiler, the discrepancy being indicative of a possible boiler failure.

The boiler may include two or more boilers configured in a boiler cascade for supplying water to the water loop and the method may further involve receiving water supply temperature readings from respective temperature sensors disposed to measure a temperature of the supply water supplied to the water loop by each boiler, and generating an alert in response to identifying a discrepancy in a time variation between the water supply temperatures, the discrepancy being indicative of a possible failure of one of the boilers.

The boiler may include a heat source operable to deliver a controllable heat output for heating the supply water and controlling the boiler to supply water at a temperature above the boiler idle temperature may involve controlling the heat source to supply a heat output based on a pre-determined temperature response as a function of time of at least one of the boiler and the hydronic heating system.

The method may involve determining the pre-determined temperature response by measuring a timed response of the at least one of the boiler and the hydronic heating system over a range of heat outputs provided by the heat source.

In accordance with another disclosed aspect there is provided a method for controlling a hot water system having a hot water tank operable to provide a hot water supply via a hot water supply pipe for consumption in at least one suite of a building, the hot water tank being heated by a hot water heating loop supplied with heated water by a boiler. The method involves establishing a temperature range for the hot water supply, the temperature range including a maximum hot water temperature and a minimum hot water temperature based at least in part on a pre-determined response of the hot water tank when heating the water. The method also involves receiving a hot water temperature reading from a temperature sensor associated with the hot water tank, and controlling the heating provided by the hot water heating loop to maintain the hot water supply within the established temperature range.

The pre-determined response of the hot water tank may be determined based on at least one of a capacity of the boiler to supply heated water to the hot water heating loop, a constraint on temperature variations within the hot water tank imposed by a construction material of the hot water tank, and a determined permissible temperature range for the hot water supply based on consumption requirements in the at least one suite.

The boiler may be further configured to supply water to a water loop in a hydronic building heating system, the water loop passing through the at least one suite in the building, and controlling the heating provided by the hot water heating loop to maintain the hot water supply within the established temperature range may involve, when the hot water temperature reading falls below the minimum hot water temperature, diverting supply water from the water loop to the hot water heating loop for a period of time sufficient to increase the hot water temperature reading above the predetermined minimum hot water temperature, and when the hot water temperature reading reaches the maximum hot water temperature, diverting supply water from the water loop to the hot water heating loop for a period of time sufficient to increase the hot water temperature reading above the minimum hot water temperature.

Receiving the hot water temperature reading may involve receiving a hot water temperature reading from a sensor in the hot water supply pipe proximate the hot water tank and the method may further involve adjusting the received temperature reading to account for a variation between the temperature in the hot water supply pipe and a temperature of the hot water supply within the hot water tank.

The method may involve monitoring time variations of the hot water temperature reading and generating an alert in response to a rapid decrease in hot water temperature indicative of a possible hot water tank failure.

In accordance with another disclosed aspect there is provided a method for controlling a hot water system having a hot water tank operable to supply hot water via a hot water supply pipe for consumption in at least one suite of a building, the hot water system including a recirculation pump for circulating water through the hot water supply pipe to maintain a minimum temperature at remote portions of the hot water supply pipe. The method involves controlling the recirculation pump to operate at a varying duty cycle based on an expected hot water consumption in the at least one suite based at least on a time of day.

In accordance with another disclosed aspect there is provided a controller apparatus for a hydronic building heating system, the hydronic heating system including a boiler for suppling water to a water loop, the water loop passing through at least one suite in the building. The apparatus includes a processor circuit operably configured to receive a suite temperature reading from a temperature sensor installed inside the at least one suite, produce a control signal causing the boiler to heat the supply water when the suite temperature reading is lower than a target temperature by an allowed variance, the target temperature being based on an expected activity in the suite. The processor circuit is also operably configured to produce a control signal causing the boiler to discontinue heating the supply water when the suite temperature reading is higher than the target temperature by an allowed variance.

In accordance with another disclosed aspect there is provided a controller apparatus for controlling a boiler to supply water to a water loop in a hydronic building heating system, the water loop passing through at least one suite in the building. The apparatus includes a processor circuit operably configured to receive an outside temperature reading from a temperature sensor installed outside of the at least one suite, and determine a boiler idle temperature based on the outside temperature reading. The processor circuit is also operably configured to produce a control signal for controlling the boiler to supply water at the idle boiler temperature in response to a determination that heating of the water within the water loop is not currently required, and produce a control signal for controlling the boiler to supply water at a temperature above the idle boiler temperature in response to a determination that heating of the water within the water loop is currently required.

In accordance with another disclosed aspect there is provided a controller apparatus for controlling a hot water system having a hot water tank operable to provide a hot water supply via a hot water supply pipe for consumption in at least one suite of a building, the hot water tank being heated by a hot water heating loop supplied with heated water by a boiler. The apparatus includes a processor circuit operably configured to establish a temperature range for the hot water supply, the temperature range including a maximum hot water temperature and a minimum hot water temperature based at least in part on a pre-determined response of the hot water tank when heating the water. The processor circuit is also operably configured to receive a hot water temperature reading from a temperature sensor associated with the hot water tank, and control the heating provided by the hot water heating loop to maintain the hot water supply within the established temperature range.

In accordance with another disclosed aspect there is provided a controller apparatus for controlling a hot water system having a hot water tank operable to supply hot water via a hot water supply pipe for consumption in at least one suite of a building, the hot water system including a recirculation pump for circulating water through the supply pipe to maintain a minimum temperature at remote portions of the hot water supply pipe. The apparatus includes a processor circuit operably configured to control the recirculation pump to operate at a varying duty cycle based on an expected hot water consumption in the at least one suite based at least on a time of day.

In accordance with another disclosed aspect there is provided a computer readable medium encoded with codes for directing a processor circuit to display a user interface for controlling a hydronic heating system in a building having a plurality of suites. The codes direct the processor circuit to display a representation of the building on a display in communication with the processor circuit, and to display at least some of the plurality of suites within the building, the suites that are displayed being selectable by a user, each suite having an indication representing a location of a temperature sensor installed inside the at least one suite. The codes also direct the processor circuit to display components of the hydronic heating system including at least a boiler for heating water supplied to a water loop, heat radiators within the plurality of suites, and portions of the water loop connecting between the hydronic heating system components, and to display current values for the temperature reading at the temperature sensor installed inside the at least one suite. The codes further direct the processor circuit to display operating parameters associated with the components of the hydronic heating system, the operating parameters including at least one of a temperature of supply water at the component and an operating status associated with the component, at least some of the operating parameters having an associated user input control for changing a value of the parameter.

In one disclosed aspect, the disclosed system facilitates complete remote monitoring and control over all pumps, valves, temperatures, boilers and hot water tanks, using a simple yet robust graphic interface, designed both for the sophisticated user, like an HVAC technician and also for the not-sophisticated user, like a building manager or owner. In accordance with another disclosed aspect, the system identifies and generates email or text message alerts with warnings of imminent problems before they actually happen, potentially preventing damage to equipment, inconvenience to tenants, and lowering repair costs.

One cause of energy inefficiency in existing systems is that temperatures outside the building or even those inside the hallway do not accurately reflect actual temperatures inside the tenant apartments, while it is these temperatures inside the tenant apartments, which we ultimately want to regulate.

In one disclosed aspect wireless temperature sensors may be located in tenant apartments as well as outside the building and on relevant inputs and output pipes in the boiler room as described below. The boilers, hot water tanks, pumps and valves may be controlled using computer controlled wired or wireless relays as well as analog 0V-10V voltage modules.

These temperature sensors and relays may be wireless, extremely small, reliable and accurate. In one disclosed aspect predictive-adaptive methods may be used to monitor and predict conditions, and then control the boilers, hot water tanks, pumps and valves to deliver the correct heat at the correct time to the different parts of the building, when needed, only as much as needed, with minute-by-minute accuracy. The eventual natural gas energy cost savings may be directly related to the existing degree of heating inefficiency in the building.

At the time of building construction, advanced temperature sensors, computers and wireless technology were not available and unlike today, natural gas and/or oil was not particularly expensive, providing little incentive for additional spending on heat efficient designs and construction.

Other aspects and features will become apparent to those ordinarily skilled in the art upon review of the following description of specific disclosed embodiments in conjunction with the accompanying figures.

### BRIEF DESCRIPTION OF THE DRAWINGS

In drawings which illustrate disclosed embodiments:

FIG. 1 is a screenshot of a user interface screen showing typical placement of temperature sensors in a building hydronic heating system;

FIG. 2 is a block diagram of a processor circuit for displaying the user interface shown in FIG. 1;

FIG. 3 is a block diagram of a controller for controlling the building hydronic heating system shown in FIG. 1;

FIG. 4 is a graph of a boiler control voltage as a function of temperature for determining a dynamic idle boiler output temperature;

FIG. 5a is a screenshot a control for customizing boiler heating control for a case where the outside temperature is higher than a high temperature Tₕ;

FIG. 5b is a screenshot a control for customizing boiler heating control for a case where the outside temperature is lower than a low temperature Tₕ;

FIG. 5c is a graph of a control voltage for controlling the boiler to provide for building heat requirements, hot water heating requirements, and a combined heating requirement as a function of the outside temperature T;

FIG. 6 is a graph of weekday hourly target temperatures;

FIG. 7 is a graph of weekend/holiday hourly target temperatures;

FIG. 8a is a graph of an allowed target heat temperature variance;

FIG. 8b is a graph showing conditions under which the boiler is turned off;

FIG. 8c is a graph showing conditions under which the boiler is turned on;

FIG. 9 is a graph of boiler heating rate as a function of time;

FIG. 10 is a screenshot of a control for setting a duty cycle of a hot water recirculation pump over a period of 24 hours;

FIG. 11a is a graph of hot water tank temperature as a function of time;

FIG. 11b is a graph of hot water tank temperature as a function of time for a boiler having a heating capacity for heating up the hot water tank quickly;

FIG. 12 is a perspective view of a hot water tank showing water temperature locations inside the tank and in an outlet pipe;

FIG. 13 is a table of backup duty cycle values for use in the event of a temperature sensor failure;

FIG. 14 is a graph of a control voltage as a function of average suite temperature for controlling a mixing valve;

FIG. 15 is a graph of temperature as a function of time for a hot water tank under failure conditions;

FIG. 16 is a schematic view of a boiler and water loop showing temperature sensor locations for identifying a possible failure in the water loop;

FIG. 17 is a graph of temperature as a function of time for a cascade of boilers;

FIG. 18a, 18b, 18c are a series of graphs showing conditions under which potentially false sensor data is generated by temperature sensors in suites;

FIG. 19a is a graph of output temperature as a function of time for a normally heating boiler;

FIG. 19b is a graph of output temperature as a function of time of a boiler indicating a potential boiler failure;

FIG. 20a is a graph of suite temperatures and boiler temperature as a function of time showing a normal correlation between boiler operation and suite temperature; and

FIG. 20b is a graph of suite temperatures and boiler temperature as a function of time showing a lack of correlation between boiler operation and suite temperature indicating building overheating or under-heating.

### DETAILED DESCRIPTION

### User Interface

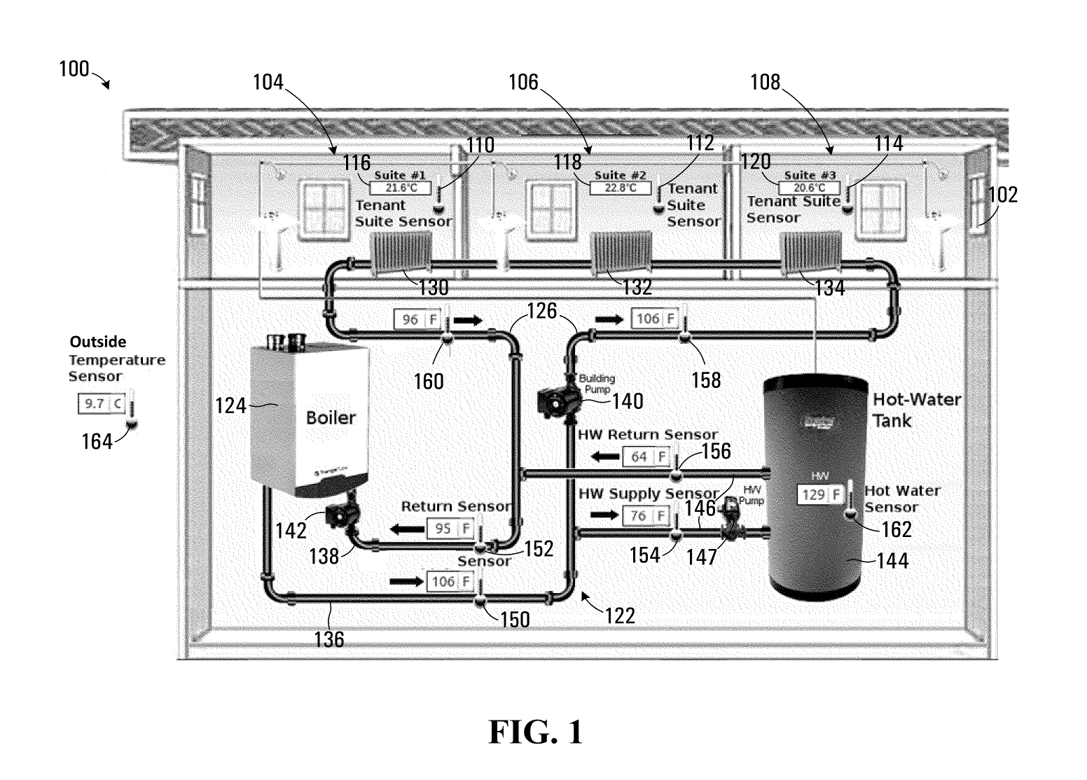

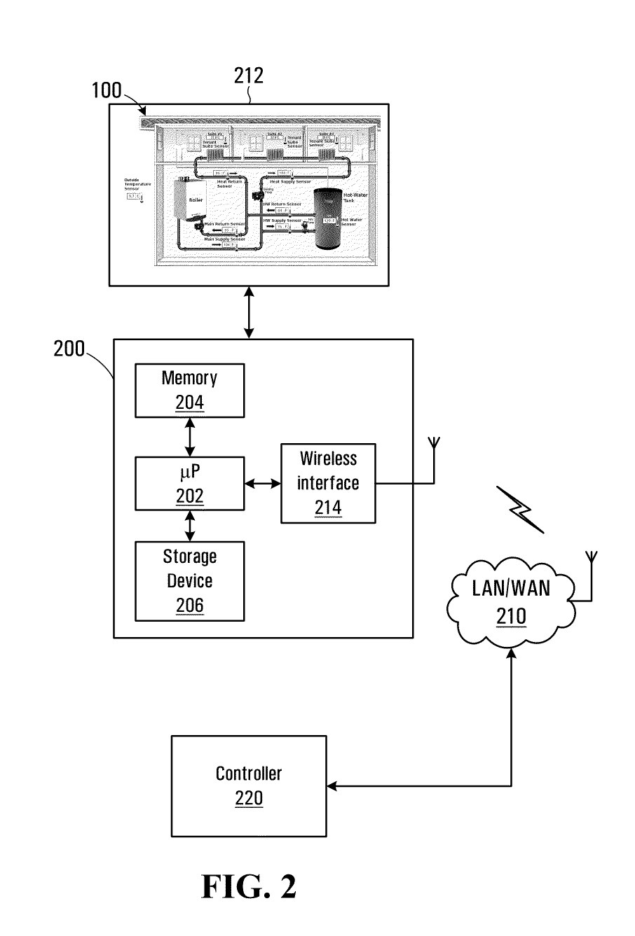

Referring to FIG. 1, a screenshot of a user interface for controlling a hydronic heating system is shown generally at 100. The user interface 100 may be displayed on a display of a computing device such as the processor circuit shown in FIG. 2. The user interface 100 includes a representation of a building 102 and suites 104, 106, and 108 of plurality of suites within the building. The suites 104, 106, and 108 out of the plurality of suites in the building 102 that are displayed may be selectable by a user. Each suite 104, 106, and 108 has a respective indication of a temperature sensor 110, 112, and 114 representing an installed location of the temperature sensors inside the suite. The indicated temperature sensors 110, 112, and 114 each have an associated temperature display 116, 118, and 120 showing a current temperature reading of the temperature sensor.

The user interface 100 also includes a display of components of a hydronic heating system 122, including at least a boiler 124 for heating water supplied to a water loop 126, heat radiators 130, 132, and 134 within the suites 104, 106, and 108, and portions of the water loop connecting between the hydronic heating system components. In the embodiment shown, the water loop 126 of the hydronic heating system 122 includes a supply line 136 and a return line 138. The supply line 136 includes a supply pump 140 and the return line 138 includes a return pump 142. The water loop carries supply water heated by the boiler, which is used to supply heat to baseboard radiators in the suites and other heated areas of the building. The supply water refers to the water that is leaving the boiler on its way through the water loop 126 to the heated areas. The return water refers to water being returned back to the boiler from the water loop 126.

The hydronic heating system 122 also includes a hot water tank 144. The hot water tank 144 provides hot water to the suites and/or public areas of the building via a supply line 170 for consumption in sinks and showers used by the occupants. The water loop 126 includes a hot water heating loop 146 operable to deliver heated water to the hot water tank 144 for heating a hot water supply for suppling hot water for consumption within the suites 104, 106, and 108. The hot water heating loop 146 includes a hot water pump 147 for circulating the hot water from the boiler 124.

The user interface 100 also includes representations of various operating parameters associated with the components of the hydronic heating system. For example, the supply pump 140 and return pump 142 may be highlighted or colored to indicate when they are operating. Temperature parameters by be indicated by temperature sensor indications at various points in the hydronic heating system 122. For example, the temperature sensors depicted may include a supply temperature sensor 150 in the supply line 136, a return temperature sensor 152 in the return line 138, a hot water supply temperature sensor 154 and return temperature sensor 156 in the hot water heating loop 146, additional supply and return temperature sensors 158 and 160 in the water loop 126, and a hot water tank temperature sensor 162 in the hot water tank 144. The building 102 also includes an outside temperature sensor 164 located outside of the building. Each sensor includes an associated display of a current temperature reading of the temperature sensor. In the embodiment shown, the display includes a control “F” or “C”, which may be used to control the temperature units used for each temperature sensor. For example, the building outdoor temperature and suite temperatures in the embodiment shown are configured in Celsius (“C”) and the remaining temperatures are configured in Fahrenheit (“F”).

Referring to FIG. 2, an embodiment of a computer processor circuit suitable for displaying the user interface 100 is shown generally at 200. The processor circuit 200 includes a microprocessor 202, a volatile memory 204, and a persistent storage device 206, all of which are in communication with the microprocessor 202. The persistent storage device 206 may be implemented as a hard disk drive or as flash memory and program codes for directing the microprocessor 202 to carry out various functions may be read from the persistent storage device. The volatile memory 204 may be implemented as a random access memory (RAM) for storing data and/or program codes.

The processor circuit 200 also includes a wireless interface 208 for connecting wirelessly to a local area network or wide area network 210. The wireless interface 208 may include a WiFi interface for connecting to the wireless local area network (LAN) and/or a cellular data interface for connecting to a wide area network such as a GSM cellular data network. The processor circuit 200 may alternatively connect to the local area network or wide area network 210 via a wired connection (not shown).

The processor circuit 200 may also be in communication with a display 212 for displaying the user interface 100. The display 212 may be a touch screen display operable to receive user input for controlling operation of the hydronic heating system via the user interface 100. In one embodiment, the user interface 100 may be implemented on a tablet or other handheld computer having a processor circuit and display generally as shown at 200 and 212 in FIG. 2, which provides for convenient control of the operations of the hydronic heating system 122 either while in the building or at a remote location.

In the embodiment shown in FIG. 2, the processor circuit 200 is in communication with a system controller 220, which is configured to interface with the various components of the hydronic heating system 122 for controlling heating operations.

### System Controller

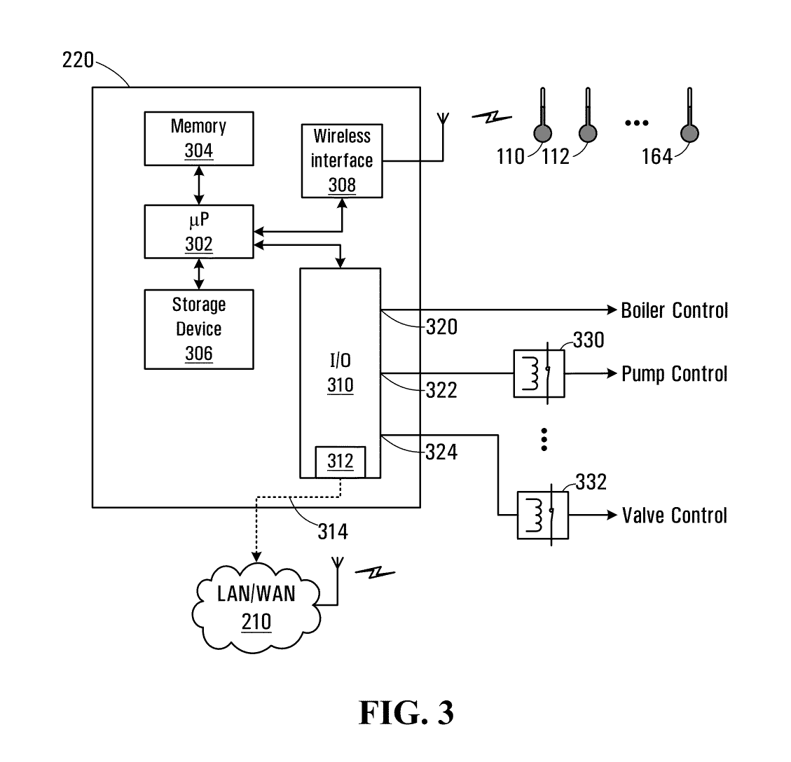

The system controller 220 is shown in greater detail in FIG. 3. Referring to FIG. 3, the controller 220 includes a microprocessor 302, a volatile memory 304, and a persistent storage device 306, all of which are in communication with the microprocessor 302. The persistent storage device 306 may be implemented as a hard disk drive or as flash memory and program codes for directing the microprocessor 202 to carry out various functions may be read from the persistent storage device. The volatile memory 304 may be implemented as a random access memory (RAM) for storing data and program codes may be loaded from persistent memory into the volatile memory to initiate functions related to controlling the hydronic heating system 122. In one embodiment the controller 220 may be implemented using a single board computer such as a Raspberry Pi is or an embedded computer controller.

The controller 220 also includes a wireless interface 308 for connecting wirelessly to the local area network or wide area network 210. The wireless interface 208 may include a WiFi interface for connecting to the wireless local area network (LAN) and/or a cellular data interface for connecting to a wide area network such as a GSM cellular data network.

In one embodiment the temperature sensors 110, 112, 114, 150, 152, 154, 156, 160, 162, and 164 may be implemented as wireless temperature sensors and the wireless interface 308 also facilitates connecting to these temperature sensors to receive temperature readings and/or determine a status of the sensor. In other embodiments some of the temperature sensors may be implemented as wired sensors.

The controller 220 also includes an input/output (I/O) 310 for interfacing with the hydronic heating system 122. The I/O 310 includes an output 320 for controlling an analog controller 324 for producing a boiler control signal for controlling the boiler 124. In one embodiment the boiler control signal produced by the analog controller 324 may be an analog DC voltage having a level between 0V and 10V. The I/O 310 also includes an output 322 for producing a relay control signal for actuating a relay 330. The relay 330 controls the operation of a pump such as the supply pump 140, return pump 142, or hot water pump 147. The I/O 310 further includes an output 324 for producing a relay control signal for actuating a relay 332. In this embodiment the relay 332 controls operation of a valve, such as a mixing valve described later herein. In the embodiment shown in FIG. 3, the I/O 310 may optionally include an interface 312 for connecting to the local area network or wide area network 210 via a wired connection 314.

In operation, the system controller 220 interfaces with the various components of the hydronic heating system 122 to control the operation of the components and receive status information. In this embodiment the system controller 220 also connects to the local area network or wide area network 210 and provides access to information related to the hydronic heating system 122 via the network by the processor circuit 200. The processor circuit 200 displays the user interface 100 on its display 212 and the user is able to view current status information associated with the hydronic heating system 122 and also interact with the various controls for controlling operations of the system. The user interface 100 displayed on the display 212 provides a graphical display showing a configuration and layout of the building 102, the suites 104, 106, and 108, and the hydronic heating system 122. The display 212 also accepts user input for interacting with the various controls and displayed elements on the user interface 100 and sends control signals via the wireless interface 208 of wired connection 214 to the local area network or wide area network 210, which in turn are communicated back to the controller 220 for controlling the hydronic heating system 122.

In the embodiment of the user interface 100 shown in FIG. 1, information is presented graphically using images of the actual machinery in the building boiler room and suites 104, 106, and 108. The user is thus able to easily relate to and understand the layout and control of the hydronic heating system 122 through the graphical user interface representation. Where manual control of various parameters of the hydronic heating system 122 is required, the user interface 100 provides for manual input of temperatures and other commands for causing various components of the system to operate.

In one embodiment, alert conditions associated with various components of the hydronic heating system 122 as described later herein may be presented graphically by changing the color and/or visual appearance of the component having a failure or warning status. Similarly the operating status of pumps and other components may be indicated by changing color of the graphical depiction and analog voltage control signals may cause a change in visual appearance based on the current control situation.

In buildings that have too many suites to display on the single user interface 100, the user may select some of the suites for display, for example by selecting suites in a particular heating zone associated with the hydronic heating system 122. In other embodiments, a user touch input on a displayed suite, may cause display of a 3D representation of the building 102 showing the location of the boiler room and the specific suite. A further user touch input may display a 2D floor layout of the selected suite, showing the location of the temperature sensor within the suite. A current expected lifetime of a battery powering the temperature sensor may also be displayed on the 2D layout.

The user interface 100 may be generated using a layout editor software module, implemented on either the processor circuit 200 or the controller 220. The layout editor allows the technician in the field to create, update, and change the user interface representation of the hydronic heating system 122 by selecting images from a pre-loaded database of elements and dragging them on the user interface at a correct location. The images may then be scaled, stretched or rotated as necessary. Similarly, a 3D layout editor may be implemented to permit the technician to easily create the 3D representation of the building, showing the location of the boiler room, suites, and temperature sensors. The 2D representation of the suite floor layout may similarly be generated by a technician in a layout editor showing the location of the temperature sensor and walls of the suite.

In one embodiment wireless temperature sensors are used in the hydronic heating system 122 to read the temperatures in 1-minute intervals, calculate the best course of action based on the temperatures and hardware configuration (boiler types, number of boilers, heating zones, self-heated or boiler-heated hot water tank etc.), and then using wired/wireless relays and analog voltage 0V-10V output modules, cause the boiler(s), hot water tank(s), pumps and valves to operate accordingly.

Using sensors in tenant's suites allows for accurate temperature reading directly from the target heating areas so the boiler can be controlled to provide the correct heat at the right time to these areas. By monitoring the temperature readings at the boiler room heating pipes inputs and outputs, it is also possible to identify system failures and improve efficient control of the boiler, as described later herein.

### Boiler Idle Temperature

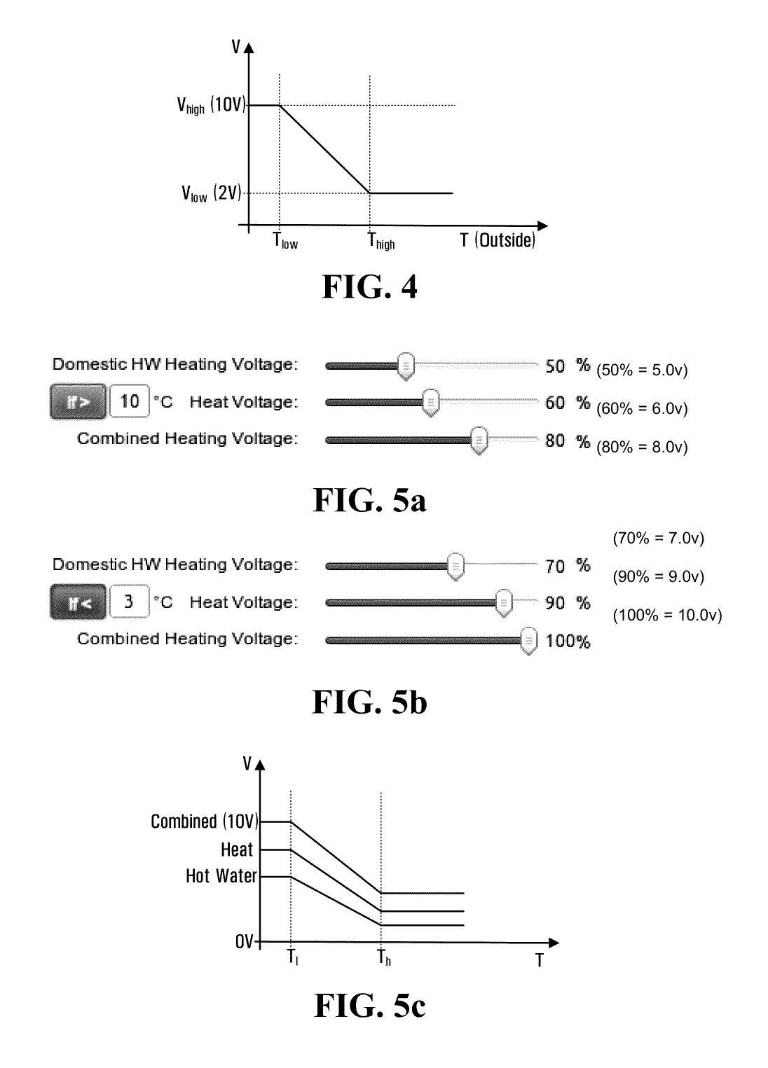

In case of a high efficiency boiler embodiment, a dynamic optimal “Idle Boiler Output Temperature” is calculated based on the outside temperature as shown graphically in FIG. 4. Manufacturers of high efficiency boilers generally recommend a boiler temperature at which the boiler works efficiently when there is no specific demand for heating of the supply water. In general the boiler is not turned off completely when heating is not required, but rather is set to its “idle” output temperature. For many boilers, turning the boiler completely on and off within short period of time uses more energy and reduces the operating life of the boiler.

The output temperature of a high efficiency boiler is generally controlled in a linear fashion by external voltage of 0V-10V, 0V meaning that the boiler is turned off and 10V corresponding to a highest boiler output temperature. Boiler manufacturers generally define a lowest voltage below with the boiler turns off (typically 2V or less). The low and high temperature points and voltage points as shown in FIG. 4 are set based on the specific boiler type being used and building geographic location (colder/warmer environment). Conventionally, high efficiency boilers are typically programmed to revert back to a fixed “idle” output temperature when their heat output is not needed and will thus be ready to provide heat when needed, avoiding the need to warm up a cold boiler. This happens through a majority of the year, even when the boiler's heat output is not required at all, or not required for a majority of the time. For example, if the boiler heat output is required 90% of the time, this practice is indeed useful and saves time and gas energy. However, if the boiler output is needed only 10% of the time, this practice actually results in considerably more gas being used than otherwise required, since the boiler could have been completely turned off 90% of the time.

In this embodiment, a dynamic idle boiler output temperature is thus defined based on the current heat needs of the system and the outside temperature. If due to weather conditions (e.g. cold weather) the boiler required to work a high percentage of the time, even when no more heat is currently required, there will be a heat requirement within a short time (likely only a few minutes). In such cases the dynamic idle boiler output temperature may be higher. If due to weather conditions (i.e. warmer weather) the boiler is working only a smaller percentage of the time the dynamic idle boiler output temperature will be lower or completely turn the boiler off. In one embodiment the boiler is controlled using a 0V-10V voltage control signal. High-efficiency boilers typically have the ability to control their output heat using an external analog voltage input in the range of 0V-10V. The graph in FIG. 4 depicts a relationship between the outside temperature (i.e. provided by the outside temperature sensor 164 in FIG. 1) and the required voltage control signal for boiler control. The relationship may be implemented as a look-up table or by using a simple formula relating outside temperature to the boiler control voltage signal level. In one embodiment a dynamic idle boiler output temperature is calculated at 1-minute intervals based on the outside temperature as shown in the graph of FIG. 4. The boiler is set to operate at the calculated dynamic idle boiler output temperature when there is no imminent heating requirement from the hydronic heating system.

In this embodiment, an outside temperature reading from a temperature sensor installed outside of the at least one suite is received and the boiler idle temperature determined based on the outside temperature reading. The temperature sensor may be located physically outside the building (i.e. exposed to the outside environmental temperature) or may be located in an un-heated or under-heated portion of the building such as a lobby, passageway, or service room. The boiler is thus controlled to supply water at the idle boiler temperature in response to a determination that heating of the water within the water loop is not currently required, and to supply water at a temperature above the idle boiler temperature in response to a determination that heating of the water within the water loop is currently required.

Referring to FIGS. 5a, 5b, and 5c a “Customized Dynamic Optimal Boiler Heating Voltage” for (1) building heat, (2) heating the domestic hot water tank or (3) combined building heating, based on outside temperature is defined. The domestic hot water tank may either have its own gas flame burner as heating source, or be heated using hot water circulating in a heating loop from the boiler, thus using the boiler heat output to heat up the domestic hot water tank as well as the building. In a situation where the boiler heat output is used also to heat up the hot water tank, when boiler heat output is required it may be for one of three reasons (heating scenarios):
a. Need to heat up the building (only)
b. Need to heat up the hot water tank (only)
c. Need to heat up both the hot water tank and the building

In conventional systems, the boiler output temperature is typically determined based on the difference between supply line (i.e. the temperature output leaving the boiler) and the return line (i.e. the temperature input returning to the boiler). As long as the difference between the supply line and return line is larger than a pre-set temperature variance (typically about 5° C.) the boiler will continue to heat the supply water. This is done under the assumption that if return line temperature is lower than supply line temperature by more than the allowed temperature variance (5° C.), heat is being emitted and dissipated into the building and/or the domestic hot water tank and boiler heat output is still required. However, this does not take in consideration the heat dissipation properties of the building and the hot water tank, which may be entirely different. In other words, it is possible that with slow heat dissipation in the building and/or the hot water tank, increasing the boiler output temperature or keeping it high, will not make the building and/or hot water talk heat up any faster, but may simply result in further gas wastage.

In the embodiment shown in FIGS. 5a, 5b, and 5c, three customized target heating levels are defined, one for each of the 3 heating scenarios above. Each heating level varies dynamically based on the outside temperature and has a value that is re-calculated in 1-minute intervals based on outside temperature. FIG. 5a shows the case where the outside temperature is higher than a high temperature Tₕ. FIG. 5b shows the case where the outside temperature is lower than a low temperature Tₗ. FIG. 5c shows a graphical depiction of the control voltage for controlling the boiler for the building heat requirement, hot water heating requirement, and the combined heating requirement as a function of the outside temperature T. Below Tₗ the voltages are as shown in FIG. 5a and above Tₕ the voltages are as shown in FIG. 5a. In the region between Tₗ and Tₕ the voltage varies linearly with temperature T. The relationship shown in the graph in FIG. 5c may be implemented as a look-up table or using a formula relating outside temperature to the boiler control voltage signal level.

### Target Temperature

In one embodiment, the boiler 124 is controlled to supply water to the water loop 126 in the hydronic building heating system. The suite temperature reading is received from temperature sensors 110, 112, and 114 installed inside the suites, causing the boiler to heat the supply water when the suite temperature reading is lower than a target temperature by an allowed variance. The target temperature is based on an expected activity in the suites. The boiler discontinues heating the supply water when the suite temperature reading is higher than the target temperature by an allowed variance. The target temperature may be pre-determined based on expected activity associated with a current time of day, an expected sleeping time of an occupant of the suite, an expected vacancy of the suite, the day of the week, weekend days, and statutory holidays, for example.

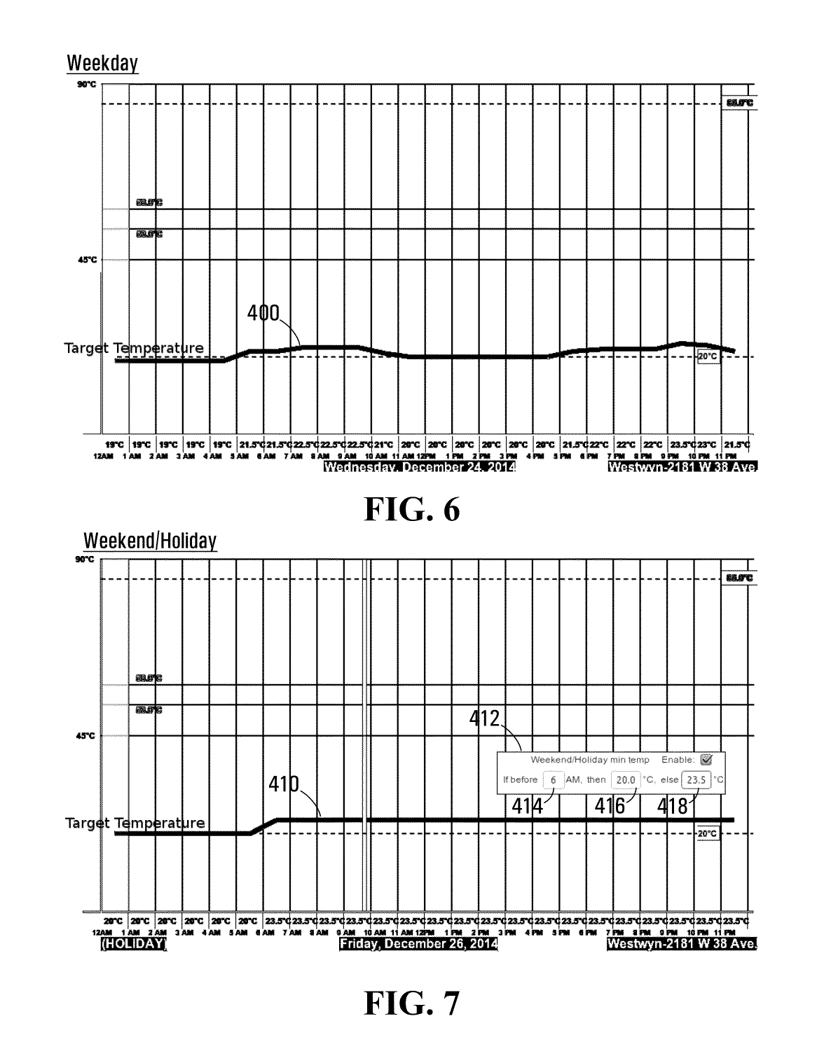

Referring to FIG. 6, a curve of weekday 24 hourly target temperatures is shown, providing customization of the target temperature curve 400 based on the building, tenant type and usage. Referring to FIG. 7, a similar curve of target temperatures 410 is shown for customization of the target temperature curve based over a weekend. The temperature inside the building will change during the day even without any man-made heat source, like a boiler due to location, sun exposure, weather season, structure heat absorbency and dissipation properties, as well as open/closed windows in the suites. This means that during the day there are times that boiler heat is required more, and there are times when heat is not required at all. In a building with residential apartment suites, boiler heat is generally needed in the morning (people wake up and get ready for work) and in the evening (people are back from work), while boiler heat is not as needed between midnight and 6 AM while most people are sleeping. The boiler heat may thus be turned completely off (a “night set back”).

Accordingly, in one embodiment to avoid heating the boiler when not needed, two sets of 24 hourly target temperatures are defined, one for weekdays (FIG. 6) and another for weekends and holidays (FIG. 7). The target temperature represents a generally desired temperature in the suites and may thus be different at different times of the day and on different days of the week. Based on the building heat absorbency and dissipation qualities, these target temperatures may be adjusted on a target temperature curve chart such as shown for optimal operation. For example, in FIG. 7 a user dialog 412 is shown that provides a time of day control 414, and two configurable temperature controls 416 and 418. The time control 416 facilitates setting of the temperature before the time of day shown in the control 414, and the time control 418 facilitates setting of the temperature after the time of day shown in the control 414.

In some embodiments, the boiler may be controlled to heat the supply water in advance of an increase in the target temperature by a period of time. The target temperature may be adjusted to account for the time-to-heat of the building and/or the boiler capacity for heating in relation to the size of the building. For example, if it takes the boiler 2 hours to increase the temperature in the suites by 1° C.-2° C., and heat is required at 6 AM, the target temperature curve may be adjusted such that the boiler starts heating up at 4 AM, thus providing the required heat at 6 AM.

In FIG. 7, a curve of target temperatures 410 is defined for weekend/holiday night set back with fixed daily temperature. Unlike weekdays, on weekends and holidays tenants may typically remain in their suites for a greater proportion of the day. In this case, a temperature set back will work only at night, but the target temperature may be generally constant during the daylight hours. Accordingly, the weekend and holiday target temperatures are set as only two distinct levels, one temperature for the night set back, and the other for the remaining time. In one embodiment, the night set back may start at midnight and stop at a customized time (for example 6 AM).

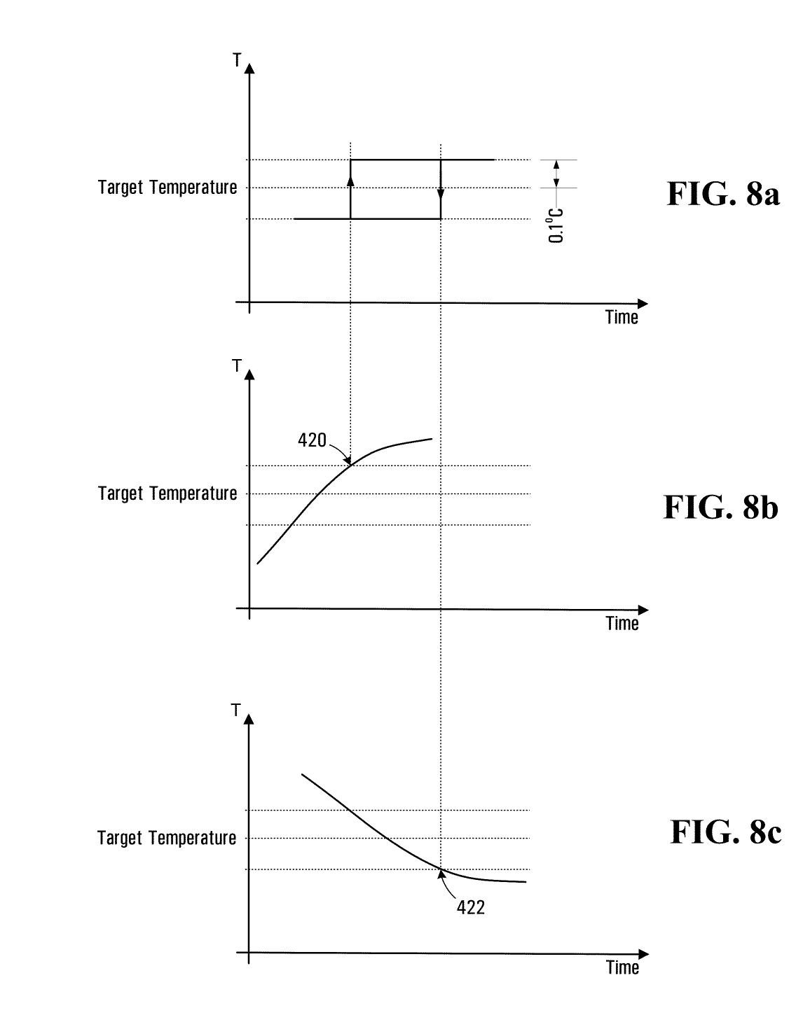

Referring to FIGS. 8a, 8b, and 8c, an allowed target heat temperature variance may be implemented for controlling components of the hydronic heating system 122 such as the boiler 124. For example, in controlling the boiler to turn on or off, borderline temperature fluctuation effects may be avoided. If for example the target temperature is 22° C. and the temperature sensor currently reads 22.01° C. and after the next one-minute interval reads 21.99° C., this may result in the boiler turning on and off minute-by-minute. This may cause a boiler malfunction, but may also waste natural gas without actually delivering heat. In one embodiment, this situation is avoided by defining a tolerance window or a target heat temperature variance (V). For a target temperature of 22° C. for example, the boiler is turned off at 420 in FIG. 8b if the sensor reads a temperature above 22° C.+V and will turn it on at 422 in FIG. 8c if it reads a temperature below 22° C.−V. The value of V may be predetermined based on the building's geographic location and heat dissipation properties of the building. A typical value for V may be about 0.5° C. or less, while in other embodiments a value of 0.1° C. may be suitable.

### Boiler Heating Rate.

When a boiler is turned on, it takes some time until the boiler's output temperature reaches the required temperature, and even more time until the building is heated up to the target temperature. Conventionally, when a boiler is turned on, the amount of gas provided for heating the supply water is as much as required to eventually operate at its target temperature. However this means that until the boiler's output temperature has reached its target temperature, the boiler receives excess heat and there is thus excess gas consumption, which could otherwise be avoided. The excess heat is lost into the environment as the supply water in the boiler cannot absorb heat at a fast enough rate. This is analogous to a gas pedal in a car: when pressed down fully, the car requires some time to reach the full speed. However, if the driver presses down on the gas pedal gradually, providing the engine only as much fuel as needed to make it go as fast as it can at each specific moment, fuel will be saved over when the gas pedal is pressed down fully.

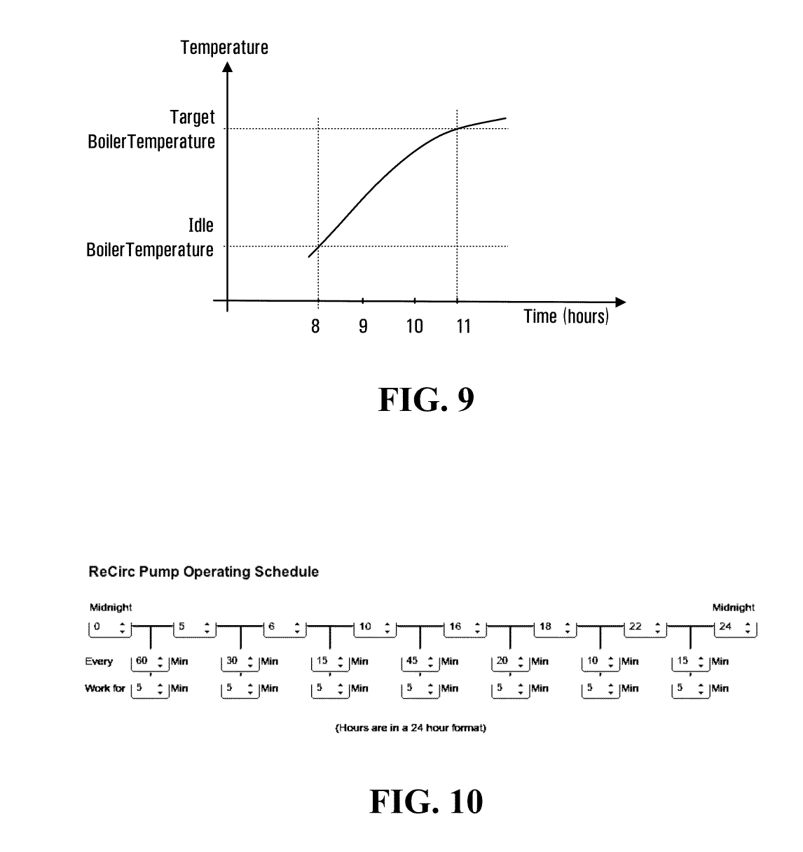

In one embodiment, when controlling a high efficiency boiler, which typically has an external voltage controlled gas heater, the gas supply may be controlled to more efficiently heat the boiler. In one embodiment, the rate at which heat can be absorbed to increase the temperature of the supply water is measured to pre-determine a boiler temperature response as a function of time. Referring to FIG. 9, a graph of boiler water temperature versus time for the boiler heating up from idle temperature to full output temperature is shown. The temperature response may be saved as a lookup table or expressed as a function. Alternatively the time to maximum temperature T may be used as a factor. Subsequently, when heating the boiler the pre-determined temperature response is used to provide the required control voltage for efficient heating of the boiler. For example, in a specific building the time to maximum boiler heat may be t minutes, requiring an eventual voltage control of Vend (=10 v) and the starting voltage of Vstart (typically 2V). Accordingly, to calculate the minute by minute voltage V, a voltage step ΔV=(Vend−Vstart)/t is calculated and the voltage control to the boiler is increased to: V=Vstart+ΔV. When the boiler is required to turn on, the control voltage provided would be Vstart (typically 2V, based on boiler manufacturer specifications) and the control voltage is increased every minute by the voltage step ΔV. The boiler thus uses a reduced amount of gas to reach its maximum output in about the same time as for the case were the heating rate is set to maximum from the outset.

### Hot Water Tank Duty Cycle.

Referring to FIG. 10, settings for control of a percentage of operation or duty cycle of a domestic hot water recirculation pump during different times of the day are shown. Some buildings may have a hot water recirculation pump, which is installed in order to draw hot water from the domestic hot water tank, circulate it through the hot water pipes and return water to the hot water tank. This is implemented such that tenant in the farthest suites from the hot water tank 144 need not wait for hot water to arrive at their faucet while colder water is flushed out of the pipes between the hot water tank and the suite. Conventionally, when installed, a recirculation pump is set to be on all the time so that all suites will have rapid access to hot water. However at times the recirculation pump capacity may be too large, causing rapid draining of the hot water tank. As a result the hot water tank may require heating much more often than it otherwise should. In one embodiment, to improve efficiency, an on/off duty cycle for the recirculation pump is set. As shown in FIG. 10, typically during the night (12 AM-6 AM) the duty cycle is set low, increasing just before morning, and then set at a mid-level during the day. The setting interface shown in FIG. 10 provides for custom adjustment of the recirculation pump duty cycle for each individual building.

### Boiler Cascade

In buildings having a cascade of boilers (i.e. having more than one boiler), boilers in the cascade may be set to work concurrently together or in an alternating fashion. Typically the boiler operation would be alternated every 2 hours in order to save gas (the more boilers working concurrently together, the more natural gas is being used). However, depending on geographic location, the outside temperature may drop to a degree that the building heating system was not typically designed to withstand for longer periods of time. In order to compensate faster for this situation, a point is set based on the outside temperature below which the regular alternating operation of the boiler is overridden. When this point is reached all boilers are activated together, regardless of the configuration setup providing sufficient heat when the outside temperature is unusually low.

When a building has more than one heating zone, it may have a pump for each zone. The more zones requiring heat at the same time, the more heated water will be required from the boiler. Based on the capacity of the individual boilers in relation to the size of the building and heating zones and the overall number of zones, it may be determined how many zones can be heated using a single boiler. Accordingly a set number N zones may be defined that may require boiler heat at the same time. If N zones or more require boiler heat, the alternating operation of the boiler is overridden to activate all boilers concurrently, regardless of the configuration setup. This way sufficient heat may be provided to all heating zones when required.

### Hot Water Tank

In some buildings the domestic hot water tank is not self-heated, meaning it does not have a dedicated gas burner and instead heated by a hot water heating loop from the boiler 124. At times the boiler may thus be required to heat up both the building and the domestic hot water tank. If the boiler does not have sufficient capacity to do both tasks concurrently within a reasonable time, or if both building and domestic hot water tank are very cold and a faster response is required, a ‘priority’ option for the domestic hot water tank may be defined. In this embodiment, boiler heat may be provided only to the domestic hot water tank until it reaches a pre-set temperature (typically about 45° C.). Once that temperature is reached, the boiler heat output will be provided to the building heat as well. Priority is thus given to heating the domestic hot water tank since the hot water supply (kitchen sink, vanity sink, and shower/bath) is considered by most tenants to have higher priority than ambient apartment heat.

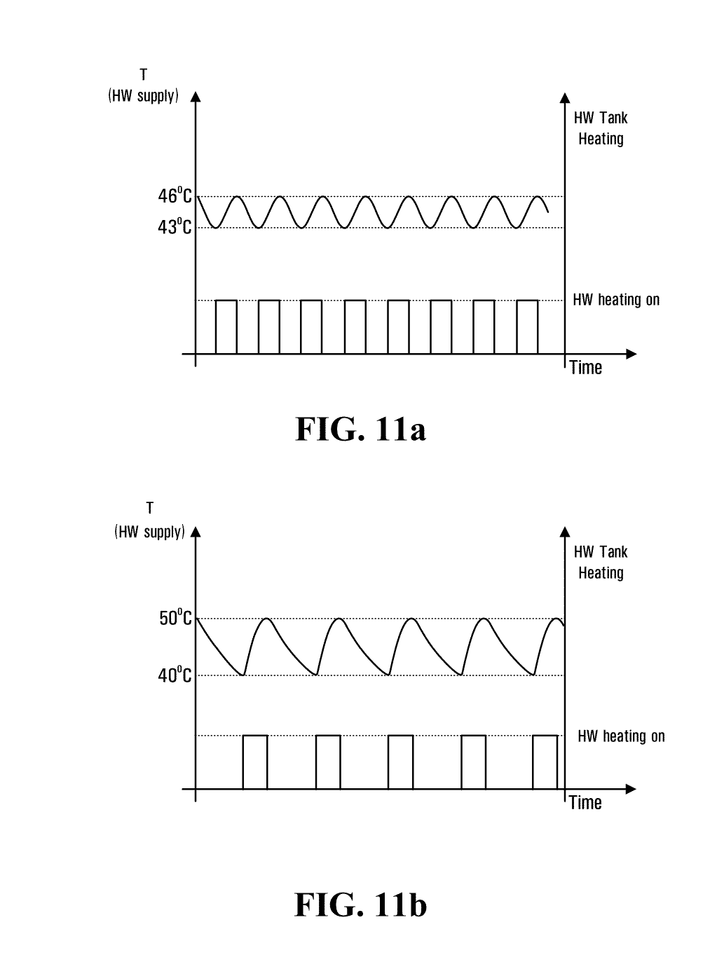

Referring to FIG. 11a and FIG. 11b, two examples of hot water tank temperature control ranges are shown. The hot water tank may be heated by a hot water heating loop from a boiler or may be self-heated, where the hot water tank has its own gas burner. In the case shown in FIG. 11a, the temperature in the hot water tank is maintained within a narrow range and thus heating is provided more often as indicated by the “HW heating on” waveform in FIG. 11a. If heated by a hot water heating loop from a boiler, the boiler will need to cycle on and off quite frequently. In the case shown in FIG. 11b, the boiler has a heating capacity for heating up the domestic hot water tank more quickly and in this embodiment a wider permitted temperature range would use considerably less energy, since the boiler is required to provide heat less often compared to the FIG. 11a case. The hot water temperature inside the domestic hot water tank is typically required to be in a range of 45° C.-55° C. and to stay relatively stable. Many widely used domestic hot water tanks are made of cast iron and large changes in temperature may cause the tank to expand and contract until it prematurely cracks and requires replacement. A stable hot water temperature is thus also important for avoiding reduction in hot water tank operating lifetime. In the case of domestic hot water temperatures, a temperature window of T-high and T-low may be defined. The domestic hot water tank is heated when its temperature is below T-low and heating stops when it is above T-high. For cast-icon domestic hot water tanks, the recommended range between T-high and T-low is 3° C.-4° C. However in cases where the domestic hot water tank is heated by the boiler and is not self-heated, the heating method above requires the boiler to either turn on/off quite often, or stay on continuously, thus consuming much more gas than actually required to keep the domestic hot water at a fixed temperature.

This situation may be avoided when using a higher quality domestic hot water tank which is not made of cast iron. When the boiler has a sufficient capacity in relation to the building, this may result in further gas savings. In one embodiment, values of T-high and T-low may be established to define a larger temperature range for operation of the hot water tank. In this case the boiler initially heats up the domestic hot water tank, but will not need to heat it up again for a longer period of time since it will take the tank longer time to cool down. Over a period of time the boiler may be required to provide less heat for heating the domestic hot water tank, thus using less gas.

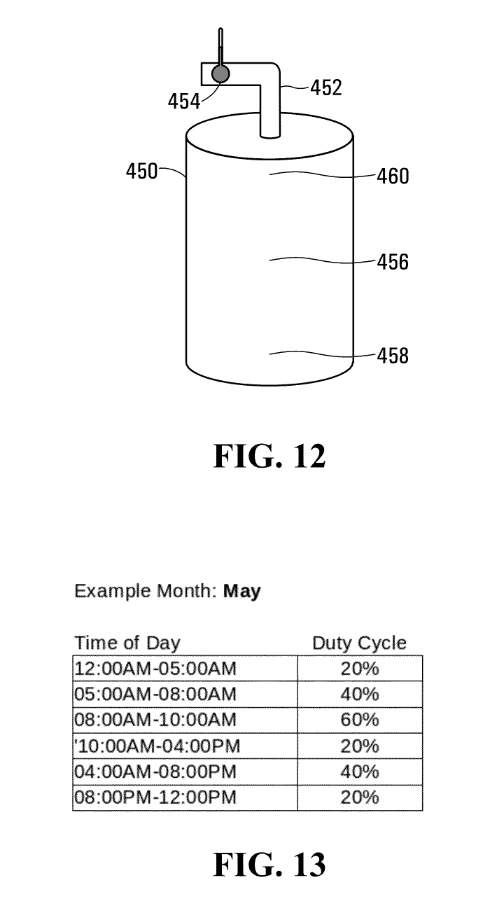

When controlling a domestic hot water tank, a relatively accurate measurement of the hot water temperature inside the tank may be required for precise control. The hot water tank 144 shown in FIG. 1 has a temperature sensor well built into the tank that accommodates the hot water tank sensor 162 for measuring the temperature. However, many hot water tanks do not have a temperature sensor well or other provision for a temperature sensor. Referring to FIG. 12, a hot water tank 450 has an outlet pipe 452 for supplying hot water to suites one alternative would be to sense the temperature of the hot water outlet pipe 452 using an outlet temperature sensor 454. However, since hot water rises in the hot water tank 450, the temperature at the top 460 is typically higher that the temperature at the center 456, which is also higher than the temperature at the bottom 458. The outlet temperature may thus be higher than the temperature of the water at the center 456 or bottom 458 by several degrees (typically 8° C.-15° C.). The difference may also not be the same for all hot water tanks and the temperature at the center of the tank 450 may not necessarily follow in direct linear relation between the outlet temperature sensor 458 and the temperature at the bottom 458. In one embodiment a compensation factor is used to reduce the reading provided by the outlet temperature sensor 454 to account for the difference between the temperature reading on the outlet pipe 452 and the actual temperature at the center 456 of the hot water tank. The compensation factor allows the temperature at the center 456 of the tank to be estimated based on the outlet temperature sensor 454 reading.

### Back-Up Operation

In one embodiment where one or more of the temperature sensors 110, 112, and 114 in the suites 104, 106 or 108 are not working, a back-up control plan mode may be initiated. The back-up control plan uses a pre-determined table of duty cycle values to set the percentage of boiler operation for each hour of the day. Referring to FIG. 13, an example of a table of duty cycle values to be used for the month of May is shown. Other tables may be generated based on expected weather patterns through the year. In another embodiment the back-up duty cycle may be based on the outside temperature rather than the month of the year, if the outside temperature sensor is working properly.

### Mixing Valve

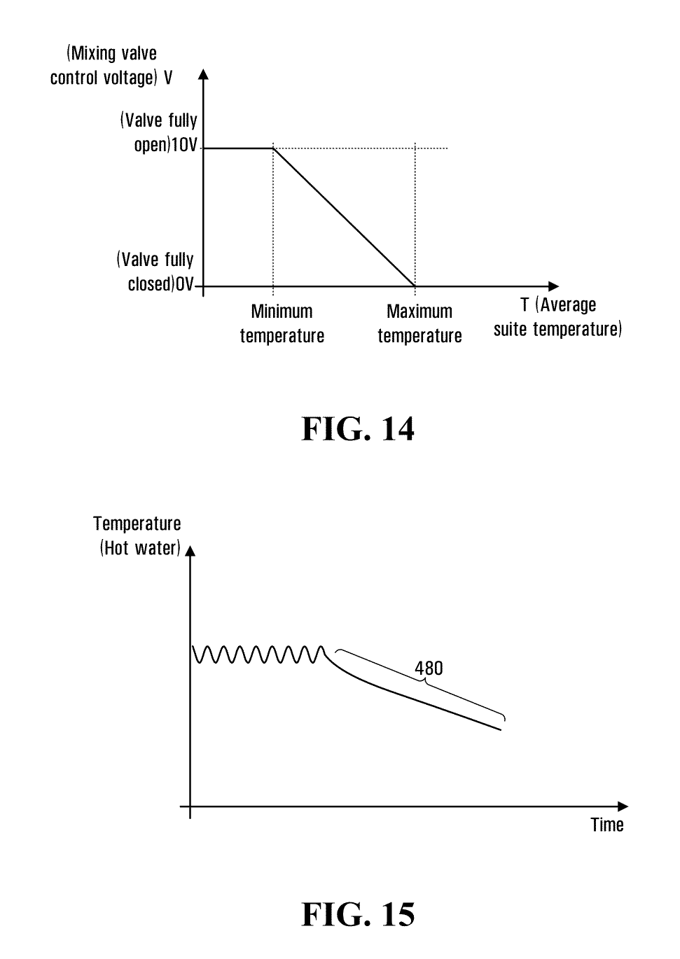

In some buildings a mixing valve may be installed in order to divert heated supply water from the working boiler or a cascade of boilers to heat the building if required, or to re-rout the excess heated supply water back to the boiler when the building is deemed to be well heated and no further heat is needed. The mixing valve controls the flow of the heating water from “100% to building”, through any ratio of “X % to building” and “Y % back to boiler”, to “100% back to boiler”. The setting of the mixing valve may be controlled by control DC voltage in the range 0V-10V. The control voltage determines if heated water goes back to the boiler or goes to heating the building, or any ratio in-between. In one embodiment, a minute-by-minute calculation of the mixing ratio is used to generate the control voltage. Using maximum and minimum tenant suite temperatures (also shown in Example 6 below), if an average of all tenant suite temperatures is equivalent to or higher than the defined maximum tenant suite temperature, the control voltage provided to the mixing valve causes all heat to be diverted back to the boiler. If the average temperature equals or is lower than the minimum tenant suite temperature, the voltage provided to the mixing valve is such that the mixing valve causes all heat to be diverted to heating the tenant suites. Control voltage values between the minimum and maximum temperatures may be determined in a linear fashion, as shown in FIG. 14.

### Failure Detection

Events that occur during operation of the heating system may have a distinctive signature with time. Based on the signature, the data produced by the various sensors in the hydronic heating system 122 may be analyzed using methods of pattern recognition. Failure modes may be identified when such events occur and an alert may be triggered. The alert may be indicated on the user interface 100 and may also cause an email and text message alert to be sent to a responsible person. In some embodiments events leading to an eventual failure may occur hours before the problem actually takes place. Various alert capabilities will now be described with reference to specific examples. It will be understood that the following examples are intended to describe possible embodiments, and variations are possible within the disclosed scope.

### Example 1

Referring to FIG. 15, in one embodiment time variations of the hot water temperature reading may be monitored and an alert may be generated in response to a rapid decrease in hot water temperature indicative of a possible hot water tank failure. Identifying when a domestic hot water tank stopped working and may be leaking may be based on pattern recognition on heating data. When a domestic hot water tank stops working, due to mechanical problem or a leak, the temperature of the hot water inside will generally decrease rapidly in a generally linear manner as shown at 480 in FIG. 15. Although it may take a few hours before tenants in the suite to notice that there is insufficient hot water supply, an early alert text or email of the problem may be sent hours before. In this manner, repairs may be started earlier and further potential damage to equipment reduced.

### Example 2

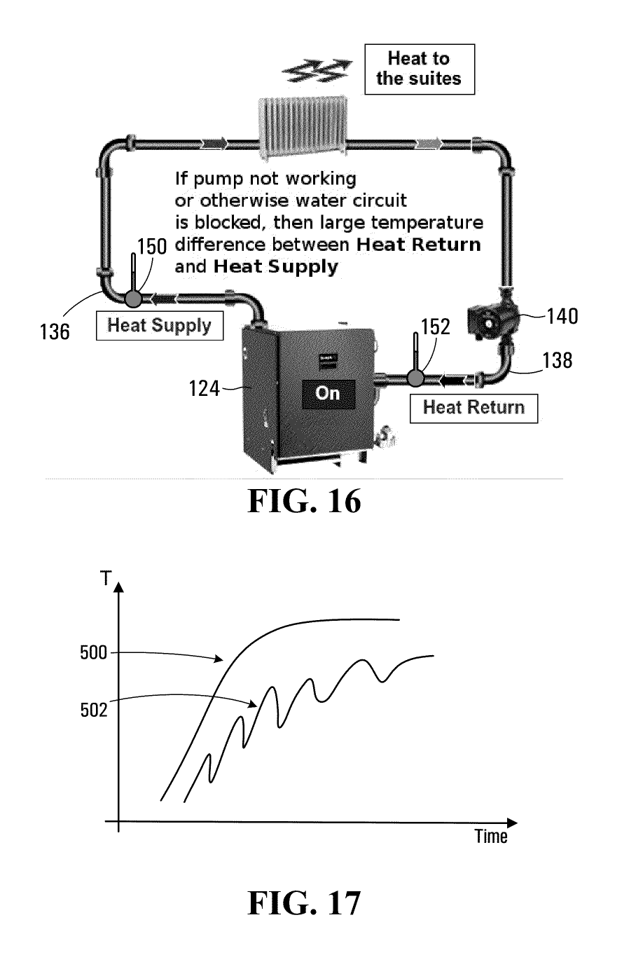

Referring to FIG. 16, in one embodiment the water supply temperature reading from the temperature sensor 150 disposed to measure a temperature of the supply water supplied to the water loop and the return line temperature reading from the temperature sensor 152 located in the return line 138 proximate the boiler may be used to generate an alert. The alert may be generated in response to a difference between the water supply temperature reading and the return line temperature reading exceeding a predetermined maximum temperature difference indicative of a possible failure in the water loop. The failure alert may indicate that the supply pump 140 has stopped working, or that the water loop is blocked. When the supply pump 140 or other zone pump malfunctions, although the boiler will start working when command to do so is received, no hot water will flow between the supply line 136 and the return line 138. As a result the heat supply temperature reading 150 will be much higher than heat return temperature reading 152 and damage to the boiler 124 may result. Another possible scenario having a similar outcome would be where there is no bypass circuit between the supply and return lines 136 and 138. Valves associated with each of the heat radiators 130, 132, and 134 may be closed by the tenants preventing flow of supply water through the water loop. When either of these situations are identified using pattern recognition methods, the boiler is turned off and an alert message is sent.

### Example 3

As disclosed above, two or more boilers may be configured in a boiler cascade for supplying water to the water loop. In one embodiment water supply temperature readings may be received from respective temperature sensors disposed to measure a temperature of the supply water supplied to the water loop by each boiler in the cascade. An alert may be generated in response to identifying a discrepancy in a time variation between the water supply temperatures, the discrepancy being indicative of a possible failure of one of the boilers. The failure may be due to a boiler in the cascade not working, or working intermittently. In FIG. 17, a graph is shown of supply temperatures for a cascade of 2 boilers while heating up. A curve 500 associated with the first boiler shows proper operation, while a curve 502 shows that the second boiler keeps turning on/off every few minutes due to a problem within the boiler.

### Example 4

In the embodiment shown in FIG. 1, the water loop 126 passes through a plurality of suites 104, 106 and 108 in the building 102. The system controller 220 (FIG. 3) thus receives suite temperature readings from each of the plurality of suites. In one embodiment the plurality of suite temperature readings may be combined to provide a single reading representative of the suites. For example, the plurality of suite temperature readings may be averaged, or a lowest suite temperature reading or a highest suite temperature reading may be used. Additionally, any of the plurality of suite temperature readings that fall outside of a reasonable range of suite temperature readings may be excluded from consideration. Alternatively or additionally, any of the plurality of suite temperature readings having a time variation that falls outside of a reasonable time variation in suite temperature readings may be used to exclude the temperature reading. In another embodiment, it may be determined that none of the plurality of suite temperature readings fall within the reasonable range of suite temperature readings and a pre-determined duty cycle for operation of the boiler may be initiated.

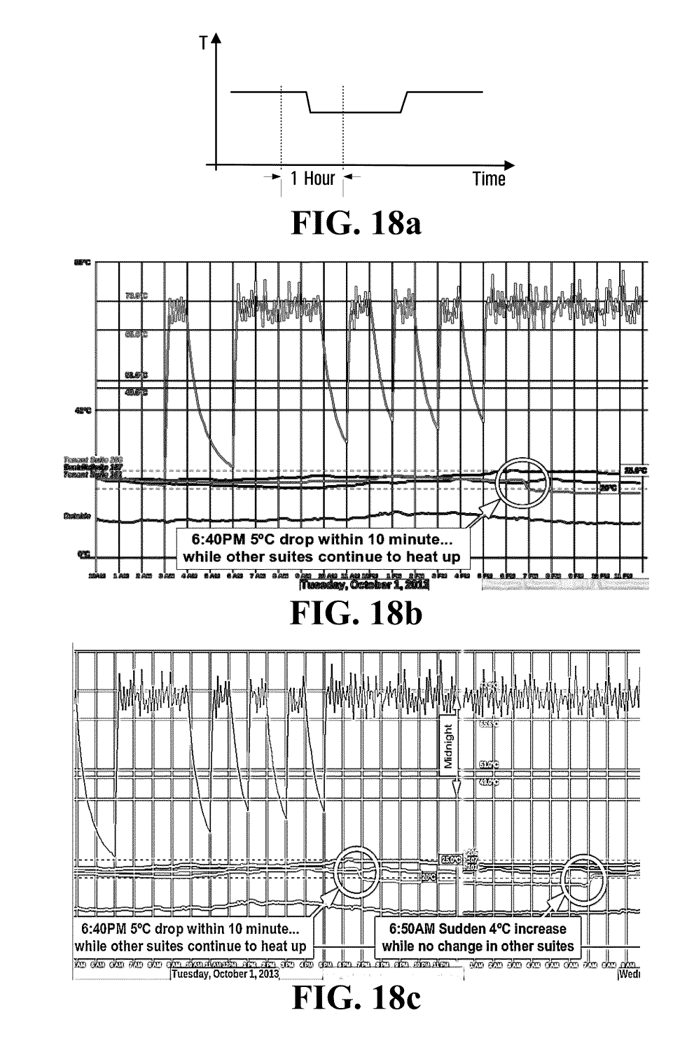

Referring to FIG. 18a, temperature readings from any of the suites may be used to identify tampering by the tenant. In this example the temperature sensor is likely being tampered with by the tenant since the temperature drops and then later goes up considerably within a fairly short period of time (FIG. 18b). Temperatures in other suites may be used as a comparison to eliminate possibility of other conditions being prevalent, since if the other tenant suites have stable readings and the boiler heating is being provided consistently then the problem is local to the specific suite. Ambient room temperature does not change as shown in FIG. 18a and would not affect only a single tenant suite.

In another embodiment if a single temperature sensor in a tenant suite is reading a considerably (X° C.) higher or lower temperature than the average temperature of the rest of the tenant suites, it may be ignored in the calculation. The value of X can be pre-determined for the system. An absolute value of ‘too high temperature’ and ‘too low temperature’ may also be defined, in order to always ignore temperature readings below or above those values. If a temperature reading is above or below these absolute values, an email or text message warning alert may be sent.

In some cases the current temperature reading may be accidentally or intentionally be influenced by the tenant of the suite. For example, if a tenant is trying to tamper with the wireless temperature sensor in the suite (for example, cooling it down hoping that the low temperature readout will activate the boiler) or the sensor is not placed in an optimal location inside the suite (for example if the sensor is too close to a kitchen stove or an open window), a temperature may be read that is much higher or much lower than the actual ambient temperature in the suite. In one embodiment a reasonable variance of suite temperature is defined in comparison to the other suites in the same heating zone. If a tenant's suite temperature is below or above the allowed variance over the average of other suite temperatures in the zone, the reading will be ignored. A previous temperature value may be used and an email or text message warning alert may be sent.

### Example 5

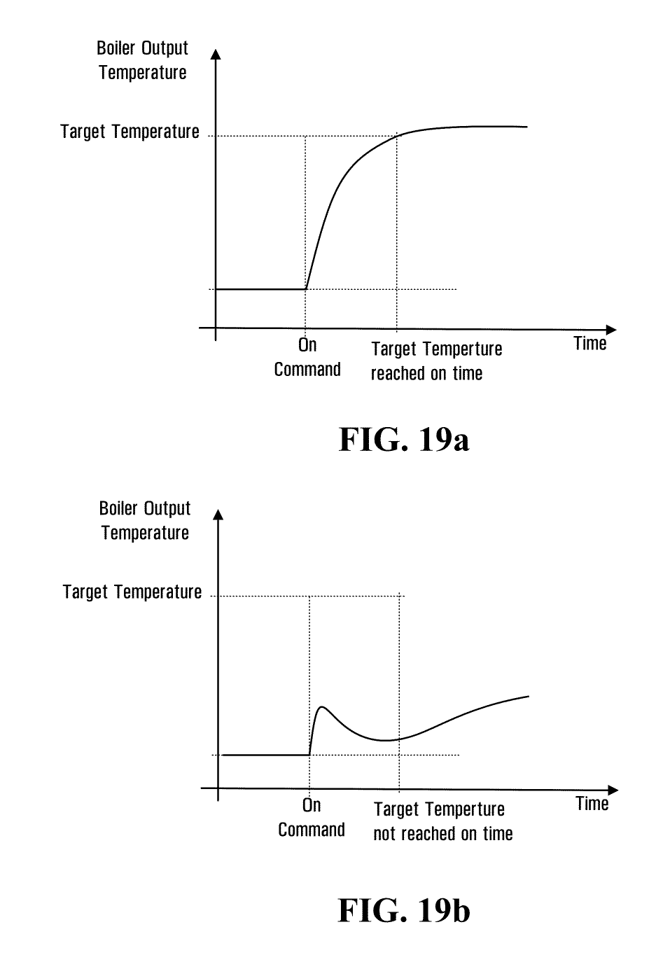

Referring to FIG. 19a, a pre-determined heat supply time variation associated with normal heating of a boiler is shown graphically. The boiler supply water temperature increases after the boiler heating commences (“On”) and teaches a target supply temperature at some time later. Referring to FIG. 19b, in one embodiment water supply temperature readings from a temperature sensor disposed to measure a temperature of the supply water supplied to the water loop by the boiler may be monitored to determine whether there is a discrepancy in relation to the normal heating curve shown in FIG. 19a. In response to identifying a significant discrepancy in the time variation of the water supply temperature from the pre-determined heat supply time variation in FIG. 19a, an alert may be triggered indicating a possible boiler failure.

Each boiler has a distinctive heat supply curve and should reach a target temperature specific to the boiler when installed in a specific building. By monitoring the time after the on command, and the supply water temperature it can be verified that the boiler is heating up normally. If a discrepancy is found, such as shown in FIG. 19b, an email or text alert may be sent warning of the potential problem.

### Example 6

In one embodiment a maximum and minimum tenant suite temperature may be detected and an alert sent if the temperature is too high or too low. A maximum and minimum temperature for a tenant suite may be defined and if the temperature in a tenant suite is above the maximum temperature or below the minimum temperature, an email/text alert may be sent.

### Example 7

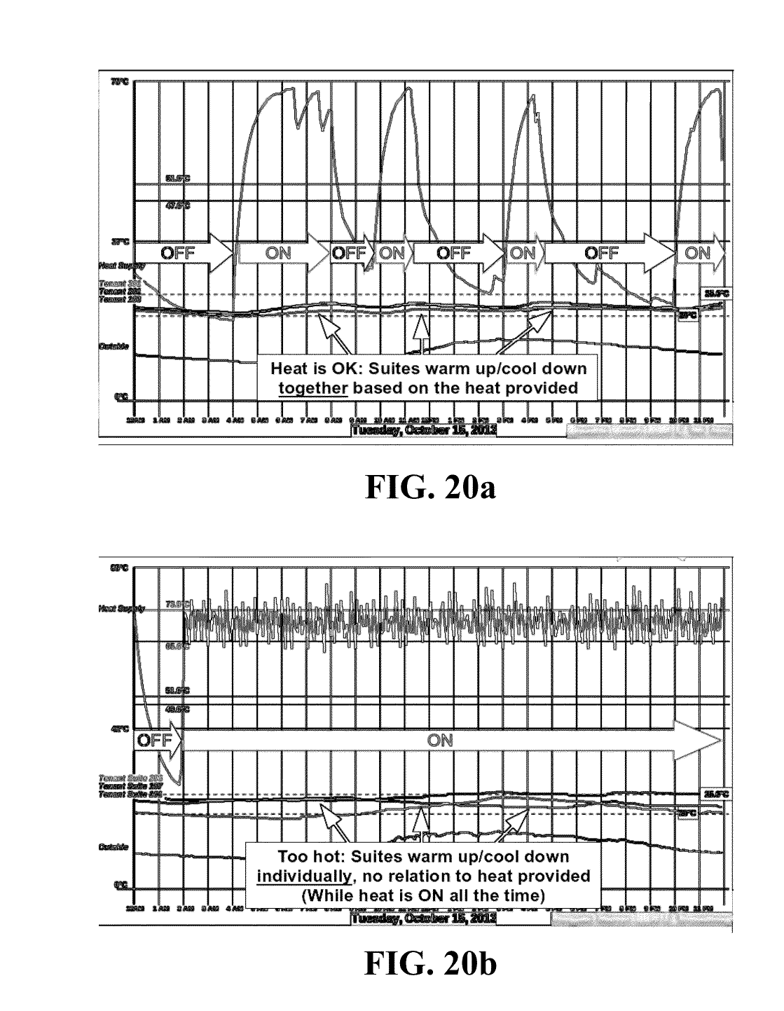

In another embodiment an alert may be generated in response to changes in suite temperature that are not correlated with operation of the boiler indicating possible overheating or under-heating of the building. When a building is heated the temperatures in tenant suites should correlate to times the boiler is turned on or off. Referring to FIG. 20a, all of the suites should have a slightly increasing temperature when the boiler turns on and slightly decreasing temperature when the boiler turns off. However when a building is being overheated tenants may regulate their suite temperature by opening windows. As a result, the temperature reading in the suites would not correlate with the times the boiler turns on or off, and also would not correlate with other suites, as shown in FIG. 20b. When the building is not overheated, the tenants would not need to open windows to cool the suite, and the temperatures in the suites would correspond to the times the boiler turns on/off and to other suites. Accordingly, using pattern recognition this situation may be identified and a warning issued when the building is being overheated or under-heated by sending text/email alerts.

### Example 8

On occasion a pump needs to be maintained, repaired or replaced rendering the pump non-operational for a period of time. The system controller 220 may try to activate the pump and may also sending alerts. A non-operating pump may be designated as being non-operational to avoid such problems. When a pump is designated as non-operational, attempts to control the pump are discontinued and control is attempted in other ways. At the same time, alerts for problems related to that pump would not be sent while the pump is designated as being non-operational.

While specific embodiments have been described and illustrated, such embodiments should be considered illustrative of the invention only and not as limiting the invention as construed in accordance with the accompanying claims.

What is claimed is:

1. A method for controlling a boiler to supply water to a water loop in a hydronic building heating system, the water loop passing through at least one suite in the building, the method comprising:
receiving a suite temperature reading from a temperature sensor installed inside the at least one suite;
causing the boiler to heat the supply water when the suite temperature reading is lower than a target temperature by an allowed variance, the target temperature being based on an expected activity in the suite; and
causing the boiler to discontinue heating the supply water when the suite temperature reading is higher than the target temperature by an allowed variance.

2. The method of claim 1 wherein the target temperature is pre-determined based on expected activity associated with one or more of a current time of day, expected sleeping time of an occupant of the suite, an expected vacancy of the suite, day of the week, weekend days, and statutory holidays.

3. The method of claim 1 wherein causing the boiler to heat the supply water comprises causing the boiler to heat the supply water at a time in advance of an increase in the target temperature by a period of time, the period of time being based on at least one of a time for the boiler to heat the supply water and a time for the heated supply water to heat the building.

4. The method of claim 1 wherein the water loop passes through a plurality of suites in the building and wherein receiving the suite temperature reading comprises receiving a plurality of suite temperature readings from at least some of the plurality of suites and further comprising combining the plurality of suite temperature readings by at least one of:
averaging the plurality of suite temperature readings;
determining a lowest suite temperature reading;
determining a highest suite temperature reading;
excluding any of the plurality of suite temperature readings that fall outside of a reasonable range of suite temperature readings;
excluding any of the plurality of suite temperature readings having a time variation that fall outside of a reasonable time variation in suite temperature readings; and
determining that none of the plurality of suite temperature readings fall within the reasonable range of suite temperature readings and initiating a pre-determined duty cycle for operation of the boiler.

5. The method of claim 1 further comprising generating an alert in response to changes in suite temperature that are not correlated with operation of the boiler indicating possible overheating or under-heating of the building.

6. A method for controlling a boiler to supply water to a water loop in a hydronic building heating system, the water loop passing through at least one suite in the building, the method comprising:
receiving an outside temperature reading from a temperature sensor installed outside of the at least one suite;
determining a boiler idle temperature based on the outside temperature reading;
controlling the boiler to supply water at the idle boiler temperature in response to a determination that heating of the water within the water loop is not currently required; and
controlling the boiler to supply water at a temperature above the idle boiler temperature in response to a determination that heating of the water within the water loop is currently required.

7. The method of claim 6 wherein receiving the outside temperature reading comprises receiving at least one of:
a temperature reading from a temperature sensor installed outside the building; and
a temperature reading from a temperature sensor installed within the building but outside of the at least one suite.

8. The method of claim 6 wherein the water loop comprises a return line for returning water to the boiler from the at least one suite and further comprising:
receiving a water supply temperature reading from a temperature sensor disposed to measure a temperature of the supply water supplied to the water loop by the boiler;
receiving a return line temperature reading from a temperature sensor located in the return line proximate the boiler; and
generating an alert in response to a difference between the water supply temperature reading and the return line temperature reading exceeding a predetermined maximum temperature difference indicative of a possible failure in the water loop.

9. The method of claim 6 further comprising:
receiving a water supply temperature reading from a temperature sensor disposed to measure a temperature of the supply water supplied to the water loop by the boiler; and
generating an alert in response to identifying a discrepancy in a time variation of the water supply temperature from a pre-determined heat supply time variation associated with the boiler, the discrepancy being indicative of a possible boiler failure.

10. The method of claim 6 wherein the boiler comprises two or more boilers configured in a boiler cascade for supplying water to the water loop and further comprising:
receiving water supply temperature readings from respective temperature sensors disposed to measure a temperature of the supply water supplied to the water loop by each boiler; and
generating an alert in response to identifying a discrepancy in a time variation between the water supply temperatures, the discrepancy being indicative of a possible failure of one of the boilers.

11. The method of claim 6 wherein the boiler comprises a heat source operable to deliver a controllable heat output for heating the supply water and wherein controlling the boiler to supply water at a temperature above the boiler idle temperature comprises controlling the heat source to supply a heat output based on a pre-determined temperature response as a function of time of at least one of the boiler and the hydronic heating system.

12. The method of claim 11 further comprising determining said pre-determined temperature response by measuring a timed response of the at least one of the boiler and the hydronic heating system over a range of heat outputs provided by the heat source.

13. A method for controlling a hot water system having a hot water tank operable to provide a hot water supply via a hot water supply pipe for consumption in at least one suite of a building, wherein the hot water tank is heated by a hot water heating loop supplied with heated water by a boiler, the method comprising:
establishing a temperature range for the hot water supply, the temperature range including a maximum hot water temperature and a minimum hot water temperature based at least in part on a pre-determined response of the hot water tank when heating the water;
receiving a hot water temperature reading from a temperature sensor associated with the hot water tank; and
controlling the heating provided by the hot water heating loop to maintain the hot water supply within the established temperature range.

14. The method of claim 13 wherein the pre-determined response of the hot water tank is determined based on at least one of:
a capacity of the boiler to supply heated water to the hot water heating loop;
a constraint on temperature variations within the hot water tank imposed by a construction material of the hot water tank; and
a determined permissible temperature range for the hot water supply based on consumption requirements in the at least one suite.

15. The method of claim 13 wherein the boiler is further configured to supply water to a water loop in a hydronic building heating system, the water loop passing through the at least one suite in the building, and wherein controlling the heating provided by the hot water heating loop to maintain the hot water supply within the established temperature range comprises:
when the hot water temperature reading falls below the minimum hot water temperature, diverting supply water from the water loop to the hot water heating loop for a period of time sufficient to increase the hot water temperature reading above the predetermined minimum hot water temperature; and
when the hot water temperature reading reaches the maximum hot water temperature, diverting supply water from the water loop to the hot water heating loop for a period of time sufficient to increase the hot water temperature reading above the minimum hot water temperature.

16. The method of claim 15 wherein receiving the hot water temperature reading comprises receiving a hot water temperature reading from a sensor in the hot water supply pipe proximate the hot water tank and further comprising adjusting the received temperature reading to account for a variation between the temperature in the hot water supply pipe and a temperature of the hot water supply within the hot water tank.

17. The method of claim 13 further comprising monitoring time variations of the hot water temperature reading and generating an alert in response to a rapid decrease in hot water temperature indicative of a possible hot water tank failure.

18. A method for controlling a hot water system having a hot water tank operable to supply hot water via a hot water supply pipe for consumption in at least one suite of a building, wherein the hot water system includes a recirculation pump for circulating water through the hot water supply pipe to maintain a minimum temperature at remote portions of the hot water supply pipe, the method comprising controlling the recirculation pump to operate at a varying duty cycle based on an expected hot water consumption in the at least one suite based at least on a time of day.

19. A controller apparatus for a hydronic building heating system, the hydronic heating system including a boiler for suppling water to a water loop, the water loop passing through at least one suite in the building, the apparatus comprising:
a processor circuit operably configured to:
receive a suite temperature reading from a temperature sensor installed inside the at least one suite;
produce a control signal causing the boiler to heat the supply water when the suite temperature reading is lower than a target temperature by an allowed variance, the target temperature being based on an expected activity in the suite; and
produce a control signal causing the boiler to discontinue heating the supply water when the suite temperature reading is higher than the target temperature by an allowed variance.

20. A controller apparatus for controlling a boiler to supply water to a water loop in a hydronic building heating system, the water loop passing through at least one suite in the building, the apparatus comprising:
a processor circuit operably configured to:
receive an outside temperature reading from a temperature sensor installed outside of the at least one suite;
determine a boiler idle temperature based on the outside temperature reading;
produce a control signal for controlling the boiler to supply water at the idle boiler temperature in response to a determination that heating of the water within the water loop is not currently required; and
produce a control signal for controlling the boiler to supply water at a temperature above the idle boiler temperature in response to a determination that heating of the water within the water loop is currently required.

21. A controller apparatus for controlling a hot water system having a hot water tank operable to provide a hot water supply via a hot water supply pipe for consumption in at least one suite of a building, wherein the hot water tank is heated by a hot water heating loop supplied with heated water by a boiler, the apparatus comprising a processor circuit operably configured to:
establish a temperature range for the hot water supply, the temperature range including a maximum hot water temperature and a minimum hot water temperature based at least in part on a pre-determined response of the hot water tank when heating the water;
receive a hot water temperature reading from a temperature sensor associated with the hot water tank; and
control the heating provided by the hot water heating loop to maintain the hot water supply within the established temperature range.

22. A controller apparatus for controlling a hot water system having a hot water tank operable to supply hot water via a hot water supply pipe for consumption in at least one suite of a building, wherein the hot water system includes a recirculation pump for circulating water through the supply pipe to maintain a minimum temperature at remote portions of the hot water supply pipe, the apparatus comprising a processor circuit operably configured to control the recirculation pump to operate at a varying duty cycle based on an expected hot water consumption in the at least one suite based at least on a time of day.

23. A computer readable medium encoded with codes for directing a processor circuit to display a user interface for controlling a hydronic heating system in a building having a plurality of suites, the codes directing the processor circuit to:
display a representation of the building on a display in communication with the processor circuit;
display at least some of the plurality of suites within the building, the suites that are displayed being selectable by a user, each suite having an indication representing a location of a temperature sensor installed inside the at least one suite;
display components of the hydronic heating system including at least a boiler for heating water supplied to a water loop, heat radiators within the plurality of suites, and portions of the water loop connecting between the hydronic heating system components;
display current values for the temperature reading at the temperature sensor installed inside the at least one suite; and
display operating parameters associated with the components of the hydronic heating system, the operating parameters comprising at least one of a temperature of supply water at the component and an operating status associated with the component, at least some of the operating parameters having an associated user input control for changing a value of the parameter.
